(19) United States
(12) Patent Application Publication
(10) Pub. No.: US 2023/0353298 A1
(43) Pub. Date: Nov. 2, 2023

(54) METHOD AND APPARATUS FOR MAPPING PUSCH REPETITIONS

(71) Applicant: Lenovo (Beijing) Ltd., Beijing (CN)

(72) Inventors: Bingchao Liu, Changping District (CN); Chenxi Zhu, Haidian District (CN); Yi Zhang, Chao Yang District (CN); Wei Ling, Changping (CN)

(73) Assignee: Lenovo (Beijing) Ltd., Beijing (CN)

(21) Appl. No.: 18/003,377

(22) PCT Filed: Jun. 28, 2020
(86) PCT No.: PCT/CN2020/098485

§ 371 Date: Dec. 27, 2022

(51) Int. Cl. H04L 5/00; H04L 1/08

(52) U.S. Cl. CPC H04L 5/0044; H04L 1/08

(57) ABSTRACT

Embodiments of the present application relate to a method and apparatus for mapping physical uplink shared channel (PUSCH) repetitions. An embodiment of the present application provides a method, which includes receiving configuration information indicating a mapping pattern of a plurality of spatial relation information and a number of nominal PUSCH repetitions of a PUSCH transmission using the plurality of spatial relation information; determining a plurality of actual PUSCH repetitions using the plurality of spatial relation information based on the number of the nominal PUSCH repetitions; and transmitting the plurality of actual PUSCH repetitions using the plurality of spatial relation information based on the mapping pattern and a mapping scheme, wherein the mapping scheme is one of: beam mapping per slot, beam mapping per nominal repetition and beam mapping per actual repetition.

### TECHNICAL FIELD

Embodiments of the present application relate to wireless communication technology, especially to a method and an apparatus for mapping physical uplink shared channel (PUSCH) repetitions.

### BACKGROUND OF THE INVENTION

New radio (NR) R16 introduced a new type of PUSCH repetition scheme, i.e., PUSCH repetition type B transmission, wherein multiple actual repetitions can be in one slot.

In NR R17, it is proposed to identify and specify features to improve reliability and robustness for channels other than physical downlink shared channel (PDSCH), which are: physical downlink control channel (PDCCH), PUSCH, and physical uplink control channel (PUCCH), using multiple transmission reception points (TRP) and/or multi-panel, with Rel.16 reliability features. Specifically, regarding PUSCH, PUSCH repetitions with multiple beams, or multiple TRPs can utilize the spatial diversity of multiple beams or TRPs of PUSCH transmission to increase the reliability and robustness. However, it is not determined how to map the repetitions of PUSCH repetition type B transmission.

Therefore, it is desirable to provide a technical solution to map the repetitions of PUSCH repetition type B.

### SUMMARY

An embodiment of the present application provides a method, which includes: receiving configuration information indicating a mapping pattern of a plurality of spatial relation information and a number of nominal PUSCH repetitions of a PUSCH transmission using the plurality of spatial relation information; determining a plurality of actual PUSCH repetitions using the plurality of spatial relation information based on the number of the nominal PUSCH repetitions; and transmitting the plurality of actual PUSCH repetitions using the plurality of spatial relation information based on the mapping pattern and a mapping scheme, wherein the mapping scheme is one of: beam mapping per slot, beam mapping per nominal repetition and beam mapping per actual repetition.

Another embodiment of the present application provides a method, which includes: transmitting configuration information indicating a mapping pattern of a plurality of spatial relation information and a number of nominal PUSCH repetitions of a PUSCH transmission using the plurality of spatial relation information; determining a plurality of actual PUSCH repetitions using the plurality of spatial relation information based on the number of the nominal PUSCH repetitions; and receiving the plurality of actual PUSCH repetitions using the plurality of spatial relation information based on the mapping pattern and a mapping scheme, wherein the mapping scheme is one of: beam mapping per slot, beam mapping per nominal repetition and beam mapping per actual repetition.

Yet another embodiment of the present application provides an apparatus, comprising: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry. The computer-executable instructions can cause the at least one processor to implement a method, which includes: receiving configuration information indicating a mapping pattern of a plurality of spatial relation information and a number of nominal PUSCH repetitions of a PUSCH transmission using the plurality of spatial relation information; determining a plurality of actual PUSCH repetitions using the plurality of spatial relation information based on the number of the nominal PUSCH repetitions; and transmitting the plurality of actual PUSCH repetitions using the plurality of spatial relation information based on the mapping pattern and a mapping scheme, wherein the mapping scheme is one of: beam mapping per slot, beam mapping per nominal repetition and beam mapping per actual repetition.

Still another embodiment of the present application provides an apparatus, comprising: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry. The computer-executable instructions can cause the at least one processor to implement a method, which includes: transmitting configuration information indicating a mapping pattern of a plurality of spatial relation information and a number of nominal PUSCH repetitions of a PUSCH transmission using the plurality of spatial relation information; determining a plurality of actual PUSCH repetitions using the plurality of spatial relation information based on the number of the nominal PUSCH repetitions; and receiving the plurality of actual PUSCH repetitions using the plurality of spatial relation information based on the mapping pattern and a mapping scheme, wherein the mapping scheme is one of: beam mapping per slot, beam mapping per nominal repetition and beam mapping per actual repetition.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates a schematic diagram of a wireless communication system in accordance with some embodiments of the present application.

FIG. 2 illustrates a flow chart of a method for wireless communications in accordance with some embodiments of the present application.

FIGS. 3(a)-5(b) respectively illustrate mapping results of exemplary methods for mapping repetitions based on different mapping patterns and mapping schemes.

FIG. 6 illustrates a block diagram of an apparatus for mapping PUSCH repetitions according to some embodiments of the present application.

FIG. 7 illustrates a block diagram of an apparatus for mapping PUSCH repetitions according to some other embodiments of the present application.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as 3GPP 5G, 3GPP LTE Release 8 and so on. Persons skilled in the art know very well that, with the development of network architecture and new service scenarios, the embodiments in the present disclosure are also applicable to similar technical problems.

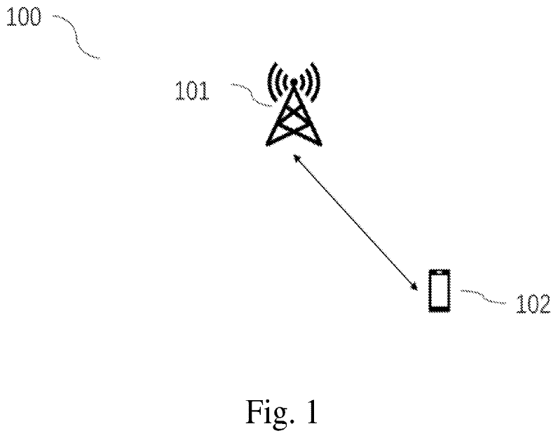

FIG. 1 illustrates a schematic diagram of a wireless communication system 100 in accordance with some embodiments of the present application.

As shown in FIG. 1, the wireless communication system 100 includes a UE 102 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 102 may include wearable devices, such as smart watches, fitness bands, optical head-mounted displays, or the like. Moreover, the UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

For PUSCH, PUSCH repetitions with multiple beams or TRPs can utilize the spatial diversity of multiple beams or TRPs of PUSCH transmission, and thus can greatly increase the reliability and robustness of uplink data transmissions. Different from PUSCH repetition Type A, wherein a PUSCH transmission in a slot of a multi-slot PUSCH transmission is omitted according to the conditions in Clause 11.1 of [6, TS38.213], a new type of PUSCH repetition scheme, i.e., PUSCH repetition type B transmission is specified in NR R16.

Specifically, in PUSCH repetition type B, concepts “nominal repetition” and “actual repetition” are introduced so that multiple repetitions within one slot will be identified. According to TS 38.214, for PUSCH repetition Type B, the number of nominal repetitions is given by the parameter numberofrepetitions, for the n^{th} nominal repetition, wherein the value of n ranges from 0 to numberofrepetitions-1, the starting slot, starting symbol, ending slot, and ending symbol of the n^{th} nominal repetition are calculated as follows:
i. the slot where the nominal repetition starts:

$${K}_{s} + ⌊ \frac{S + n \cdot L}{{N}_{symb}^{slot}} ⌋ \qquad ( 1 )$$

ii. the starting symbol relative to the start of the slot:

mod(S+n·L,N_{symb}^{slot}) (2)
iii. the slot where the nominal repetition ends:

$${K}_{s} + ⌊ \frac{S + ( n + 1 ) \cdot L - 1}{{N}_{s y m b}^{slot}} ⌋ \qquad ( 3 )$$

iv. the ending symbol relative to the start of the slot:

mod(S+(n+1)·L−1,N_{symb}^{slot}) (4)

Wherein K_{S} is the slot where the PUSCH transmission starts, and N_{symb}^{slot} is the number of symbols per slot, S is the starting symbol S relative to the start of the slot, and L is the number of consecutive symbols L counting from the symbol S allocated for each nominal repetition of a PUSCH repetition Type B transmission. S and L are respectively provided by the parameters: startSymbol and length of the indexed row of the resource allocation table.

Meanwhile, for PUSCH repetition Type B, among the starting symbol to the ending symbol, there might be one or more invalid symbols. The UE determines these invalid symbols for PUSCH repetition Type B transmission based on the following rules:
i. A symbol that is indicated as downlink by tdd-UL-DL-ConfigurationCommon or tdd-UL-DL-ConfigurationDedicated. Since the symbol is indicated to be used for downlink transmission, the UE considers that the symbol cannot be used for uplink transmission. Thus, the symbol is an invalid symbol for PUSCH repetition Type B transmission.
ii. The UE may be configured with the high layer parameter InvalidSymbolPattern, which provides a symbol level bitmap spanning one or two slots, e.g., high layer parameter symbols given by InvalidSymbolPattern. A bit value equal to 1 in the symbol level bitmap symbols indicates that the corresponding symbol is an invalid symbol for PUSCH repetition Type B transmission. The UE may be additionally configured with a time-domain pattern, e.g., high layer parameter periodicityAndPattern given by InvalidSymbolPattern, where each bit of periodicityAndPattern corresponds to a unit equal to a duration of the symbol level bitmap symbols, and a bit value equal to 1 indicates that the symbol level bitmap symbols is present in the unit. The periodicityAndPattern can be {1, 2, 4, 5, 8, 10, 20 or 40} units long, but maximum of 40 ms. The first symbol of periodicityAndPattern every 40 ms/P periods is a first symbol in frame nf mod 4=0, where P is the duration of periodicityAndPattern in units of ms. When the parameter periodicityAndPattern is not configured, for a symbol level bitmap spanning two slots, the bits of the first and second slots correspond respectively to even and odd slots of a radio frame, and for a symbol level bitmap spanning one slot, the bits of the slot correspond to every slot of a radio frame. If the parameter InvalidSymbolPattern is configured, when the UE applies the invalid symbol pattern is determined as follows:
   a) if the PUSCH is scheduled by downlink control information (DCI) format 0_1, or corresponds to a Type 2 configured grant activated by DCI format 0_1, and if InvalidSymbolPatternlndicator-ForDCIFormat0_1 is configured, if invalid symbol pattern indicator field is set 1, the UE applies the invalid symbol pattern; otherwise, the UE does not apply the invalid symbol pattern;
   b) if the PUSCH is scheduled by DCI format 0_2, or corresponds to a Type 2 configured grant activated by DCI format 0_2, and if InvalidSymbolPatternlndicator-ForDCIFormat0_2 is configured, if invalid symbol pattern indicator field is set 1, the UE applies the invalid symbol pattern; otherwise, the UE does not apply the invalid symbol pattern;
   c) otherwise, the UE applies the invalid symbol pattern.

After determining the invalid symbol(s) for PUSCH repetition type B transmission for each nominal repetition, the remaining symbols are considered as potentially valid symbols for PUSCH repetition Type B transmission. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot. An actual repetition with a single symbol is omitted except for the case of the number of consecutive symbols L is one, e.g., L=1. An actual repetition is omitted according to the conditions in Clause 11.1 of [6, TS38.213]. The redundancy version to be applied on the n^{th} actual repetition (with the counting including the actual repetitions that are omitted) is determined according to table 6.1.2.1-2.

The above descriptions on nominal repetition and actual repetition are provided according to TS 38.214, which may be changed or updated as the evolution of 3GPP specifications or other related specifications/protocols, and thus should not be limited to the above.

However, since multiple slots may be used to transmit a PUSCH repetition Type B transmission while multiple actual PUSCH repetitions can be within a single slot, mapping repetitions of the PUSCH repetition Type B cannot be performed in a similar way to a slot level time-division multiplexing (TDM) scheme, i.e., the PDSCH ultra reliable low latency communications (URLLC) scheme 4. Given that, embodiments of the present application at least propose a technical solution of mapping PUSCH repetitions when multiple spatial relation information, which may represent beam in embodiments of the present application are configured to utilize the spatial diversity to increase the robustness and reliability.

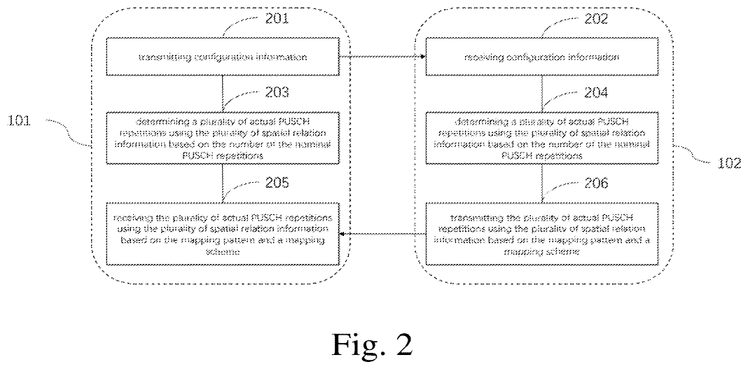

FIG. 2 illustrates a flow chart of a method for mapping PUSCH repetitions in accordance with some embodiments of the present application. Although the method is illustrated in a system level by a UE and a BS (e.g., UE 102 and BS 101 as illustrated and shown in FIG. 1), persons skilled in the art can understand that the method implemented in the UE and that implemented in the BS can be separately implemented and incorporated by other apparatus with the like functions.

In the exemplary method shown in FIG. 2, in step 201, the network side, e.g., a BS 101 as shown in FIG. 1 may transmit configuration information to a UE 102, e.g., by a RRC signaling and/or DCI. Correspondingly, in step 202, UE 102 may receive the configuration information from the BS 101. The configuration information indicates a mapping pattern of a plurality of spatial relation information and a number of nominal PUSCH repetitions of a PUSCH transmission using the plurality of spatial relation information. The PUSCH transmission may be a PUSCH repetition Type B transmission. The mapping pattern of a plurality of spatial relation information indicates the mapping between configured spatial relation information (beam) and a transmit unit which can be a slot, a nominal repetition, or an actual repetition which is determined by a mapping scheme described below, for example, indicating a UE to use which beam to transmit each allocated slot, each nominal repetition or each actual repetition of the PUSCH transmission. The mapping pattern of the plurality of spatial relation information may be any mapping pattern, e.g., cyclical mapping pattern, or sequential mapping pattern, which have been agreed by 3GPP.

For example, for two spatial relationship information, e.g., spatial relation information #1, and spatial relation information #2, when the cyclical mapping pattern is enabled, the first and second spatial relationship information are applied to the first and second transmit units, respectively, and the same mapping pattern continues to the remaining transmit units. Accordingly, the cyclical mapping pattern might be #1 #2 #1 #2 #1 #2 #1 #2 . . . . When the sequential mapping pattern is enabled, the first spatial relationship information is applied to the first and second transmit units, and the second spatial relationship information is applied to the third and fourth transmit units, and the same TCI mapping pattern continues to the remaining transmit units. Accordingly, the sequential mapping pattern might be #1 #1 #2 #2 #1 #1 #2 #2 . . . .

In step 204, a plurality of actual PUSCH repetitions using the plurality of spatial relation information based on the number of the nominal PUSCH repetitions may be determined by the UE.

In step 206, the plurality of actual PUSCH repetitions using the plurality of spatial relation information based on the mapping pattern and a mapping scheme may be transmitted. The mapping scheme may be one of: beam mapping per slot, beam mapping per nominal repetition and beam mapping per actual repetition. In other words, the plurality of actual PUSCH repetitions are mapped to the plurality of spatial relation information based on the mapping pattern, e.g., the cyclical mapping pattern or the sequential mapping pattern, and also based on beam mapping per slots, beam mapping per nominal repetition, or beam mapping per actual repetition.

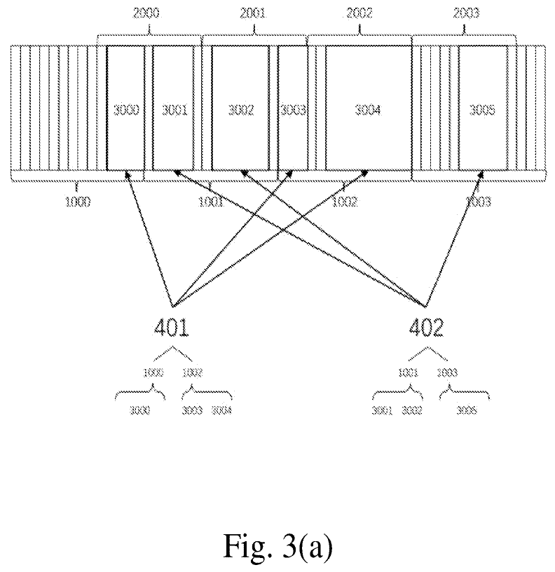

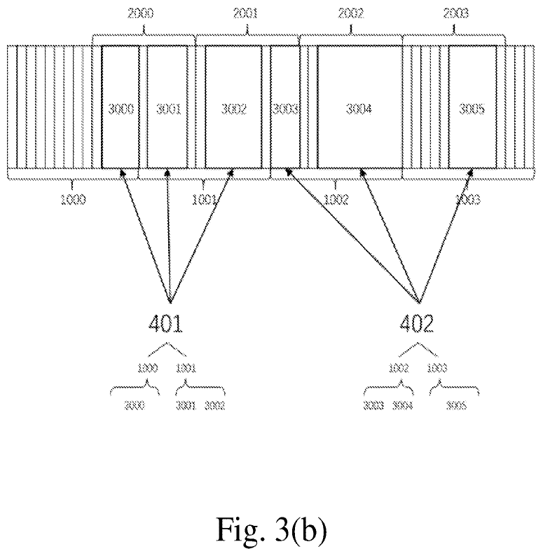

For example, in some embodiments of the present application, when the mapping scheme is beam mapping per slot, a UE may associate each slot of a plurality of allocated slots for the PUSCH transmission with a corresponding spatial relation information of the plurality of spatial relation information based on the mapping pattern, and transmit all actual PUSCH repetitions within each single slot using the corresponding spatial relation information associated with the single slot. More specific embodiments can refer to FIG. 3(a) and FIG. 3(b), which will be illustrated in detail in the following text.

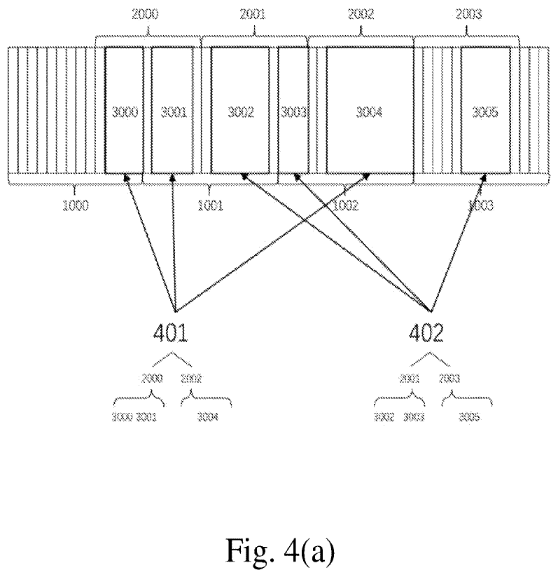

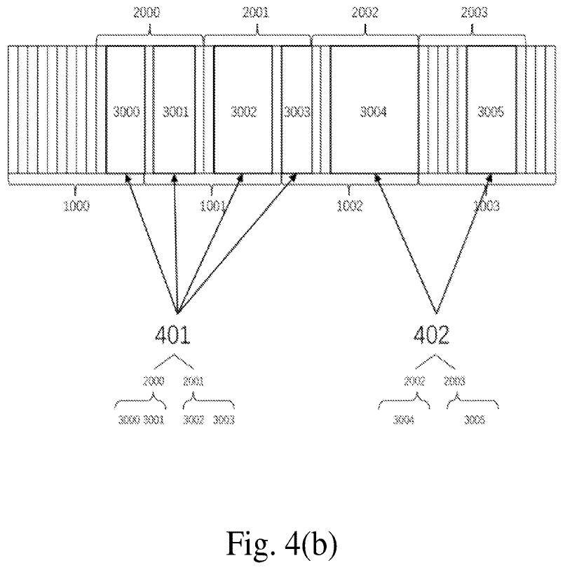

In some other embodiments of the present application, when the mapping scheme is beam mapping per nominal repetition, the UE may associate each nominal PUSCH repetition of the PUSCH transmission with a corresponding spatial relation information of the plurality of spatial relation information based on the mapping pattern, and transmit all actual PUSCH repetitions within each single nominal PUSCH repetition using the corresponding spatial relation information associated with the single nominal PUSCH repetition. More specific embodiments can refer to FIG. 4(a) and FIG. 4(b), which will be illustrated in detail in the following text.

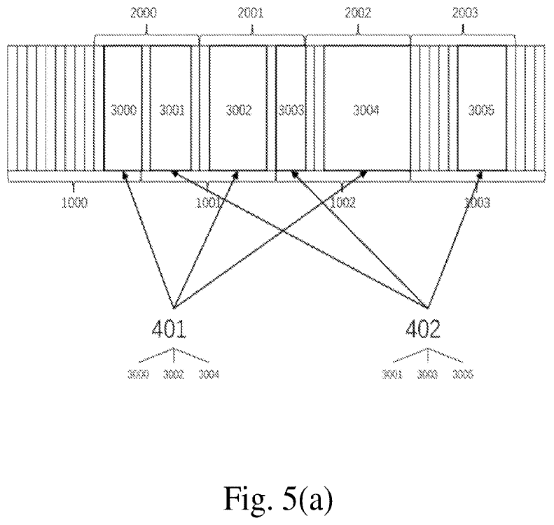

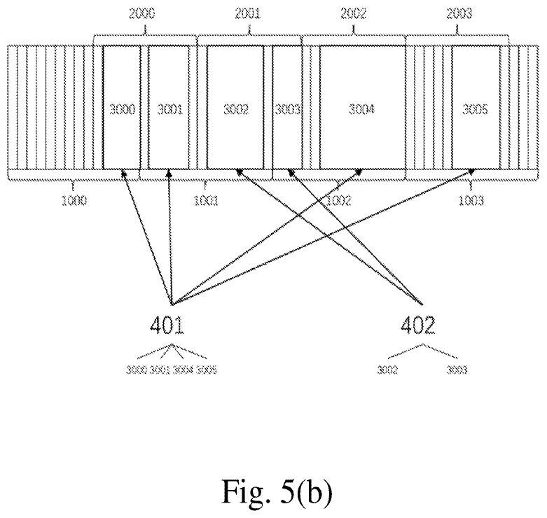

In yet some other embodiments of the present application, when the mapping scheme is beam mapping per actual repetition, the UE may associate each of the plurality of actual PUSCH repetitions with a corresponding spatial relation information of the plurality of spatial relation information based on the mapping pattern. Each of the plurality of actual PUSCH repetitions will be transmitted with a corresponding spatial relation information of the plurality of spatial relation information based on the mapping pattern. More specific embodiments can refer to FIG. 5(a) and FIG. 5(b), which will be illustrated in detail in the following text.

Similarly, in the network side, in step 203, a plurality of actual PUSCH repetitions using the plurality of spatial relation information based on the number of the nominal PUSCH repetitions may be determined in the network side, e.g., by the BS. In step 205, the BS may receive the plurality of actual PUSCH repetitions using the plurality of spatial relation information based on the mapping pattern and a mapping scheme. The mapping scheme adopted in the BS is consistent with that applied in the UE, and may be one of: beam mapping per slot, beam mapping per nominal repetition and beam mapping per actual repetition.

For example, in some embodiments of the present application, when the mapping scheme is beam mapping per slot, the BS may associate each slot of a plurality of allocated slots for the PUSCH transmission with a corresponding spatial relation information of the plurality of spatial relation information based on the mapping pattern, and receive all actual PUSCH repetitions within each single slot using the corresponding spatial relation information associated with the single slot.

In some other embodiments of the present application, when the mapping scheme is beam mapping per nominal repetition, the BS may associate each nominal PUSCH repetition of the PUSCH transmission with a corresponding spatial relation information of the plurality of spatial relation information based on the mapping pattern, and receive all actual PUSCH repetitions within each single nominal PUSCH repetition using the corresponding spatial relation information associated with the single nominal PUSCH repetition.

In yet some other embodiments of the present application, when the mapping scheme is beam mapping per actual repetition, the BS may associate each of the plurality of actual PUSCH repetitions with a corresponding spatial relation information of the plurality of spatial relation information based on the mapping pattern. Each of the plurality of actual PUSCH repetitions will be received with a corresponding spatial relation information of the plurality of spatial relation information based on the mapping pattern.

FIGS. 3(a)-5(b) respectively illustrate mapping results of exemplary methods for mapping repetitions based on different mapping patterns and mapping schemes according to some embodiments of the present application. In FIGS. 3(a)-5(b), for simplification and clearness, only two spatial relation information and four nominal repetitions of a PUSCH repetition Type B transmission are illustrated. The two spatial relation information may be two beams, e.g., beam 401 and beam 402. The four nominal repetitions are nominal repetition 2000, nominal repetition 2001, nominal repetition 2002, and nominal repetition 2003, and are respectively transmitted in 4 slots, e.g., slot 1000, slot 1001, slot 1002, and slot 1003. Moreover, assuming that there are 6 actual repetitions for this PUSCH repetition Type B transmission, they are actual repetition 3000, actual repetition 3001, actual repetition 3002, actual repetition 3003, actual repetition 3004 and actual repetition 3005 respectively.

From the perspective of slots, actual repetition 3000 is in slot 1000, actual repetitions 3001 and 3002 are in slot 1001, actual repetitions 3003 and 3004 are in slot 1002, and actual repetition 3005 is in slot 1003.

From the perspective of nominal repetitions, actual repetitions 3000 and 3001 are in nominal repetition 2000, actual repetitions 3002 and 3003 are in nominal repetition 2001, actual repetition 3004 is in nominal repetition 2002, and actual repetition 3005 is in nominal repetition 2003.

It should be noted that there may be other numbers of slots, other number of nominal repetitions, and other number of actual repetitions, and the solutions of the present application also apply to the scenarios with other numbers of slots, nominal repetitions and actual repetitions.

Specifically, FIG. 3(a) illustrates a mapping result of an exemplary method for mapping repetitions based on cyclical mapping pattern and beam mapping per slot according to some embodiments of the present application.

As stated above, when the mapping scheme is beam mapping per slot, a UE may associate each slot of a plurality of allocated slots for the PUSCH transmission with a corresponding spatial relation information of the plurality of spatial relation information based on the mapping pattern. Accordingly, in FIG. 3(a), based on the cyclical mapping pattern, the first slot, i.e., slot 1000 is associated with spatial relation information 401, e.g., beam 401; the second slot, i.e., slot 1001 is associated with spatial relation information 402, e.g., beam 402; the third slot, i.e., slot 1002 is associated with spatial relation information 401; and the fourth slot, i.e., slot 1003 is associated with spatial relation information 402.

Furthermore, when the mapping scheme is beam mapping per slot, all actual PUSCH repetitions within each single slot will be transmitted using the corresponding spatial relation information associated with the single slot. Based on the above, slot 1000 and slot 1002 are associated with spatial relation information 401, and actual repetition 3000 is in slot 1000, actual repetitions 3003 and 3004 are in slot 1002. Accordingly, spatial relation information 401 is used to transmit actual repetitions 3000, 3003, and 3004. Similarly, slot 1001 and slot 1003 are associated with spatial relation information 402, and actual repetitions 3001 and 3002 are in slot 1001, and actual repetition 3005 is in slot 1003. Accordingly, spatial relation information 402 is used to transmit actual repetitions 3001, 3002, and 3005.

Other number of spatial relation information is also supported in the present application, for example, when there are three spatial relation information, e.g., #1, #2 and #3, then the cyclical mapping pattern is #1 #2 #3 #1 #2 #3 . . . . Then slot 1000 and slot 1003 are associated with spatial relation information 401, slot 1001 is associated with spatial relation information 402, and slot 1002 is associated with spatial relation information 403.

FIG. 3(b) illustrates a mapping result of another exemplary method for mapping repetitions based on sequential mapping pattern and beam mapping per slot according to some embodiments of the present application.

Similarly, when the mapping scheme is beam mapping per slot, a UE may associate each slot of a plurality of allocated slots for the PUSCH transmission with a corresponding spatial relation information of the plurality of spatial relation information based on the mapping pattern. Accordingly, in FIG. 3(b), based on sequential mapping pattern, the first slot, e.g., slot 1000, and the second slot, e.g., slot 1001 are associated with spatial relation information 401, e.g., beam 401, and the third slot, e.g., slot 1002, and the fourth slot, e.g., slot 1003 are associated with spatial relation information 402.

Furthermore, when the mapping scheme is beam mapping per slot, all actual PUSCH repetitions within each single slot will be transmitted using the corresponding spatial relation information associated with the single slot. Based on the above, slot 1000 and slot 1001 are associated with spatial relation information 401, actual repetition 3000 is in slot 1000, and actual repetitions 3001 and 3002 are in slot 1001. Accordingly, spatial relation information 401 is used to transmit actual repetitions 3000, 3001, and 3002. Similarly, slot 1002 and slot 1003 are associated with spatial relation information 402, actual repetitions 3003 and 3004 are in slot 1002, and actual repetition 3005 is in slot 1003. Accordingly, spatial relation information 402 is used to transmit actual repetitions 3003, 3004, and 3005.

FIG. 4(a) illustrates a mapping result of an exemplary method for mapping repetitions based on cyclical mapping pattern and beam mapping per nominal repetition according to some embodiments of the present application.

As stated above, when the mapping scheme is beam mapping per nominal repetition, a UE may associate each nominal repetition with a corresponding spatial relation information of the plurality of spatial relation information based on the mapping pattern. Accordingly, in FIG. 4(a), based on the cyclical mapping pattern, the first nominal repetition, i.e., nominal repetition 2000 is associated with spatial relation information 401, e.g., beam 401; the second nominal repetition, i.e., nominal repetition 2001 are associated with spatial relation information 402, e.g., beam 402; the third nominal repetition, i.e., nominal repetition 2002 is associated with spatial relation information 401, e.g., beam 401; and the fourth nominal repetition, i.e., nominal repetition 2003 is associated with spatial relation information 402, e.g., beam 402.

Furthermore, when the mapping scheme is beam mapping per nominal repetition, all actual PUSCH repetitions within each single nominal repetition will be transmitted using the corresponding spatial relation information associated with the single nominal repetition. Based on the above, nominal repetition 2000 and nominal repetition 2002 are associated with spatial relation information 401, e.g., beam 401, and actual repetitions 3000 and 3001 are in nominal repetition 2000, actual repetition 3004 is in nominal repetition 2002, thus spatial relation information 401 is used to transmit actual repetitions 3000, 3001, and 3004. Similarly, nominal repetition 2001 and nominal repetition 2003 are associated with spatial relation information 402, e.g., beam 402, and actual repetitions 3002 and 3003 are in nominal repetition 2001, and actual repetition 3005 is in nominal repetition 2003. Accordingly, spatial relation information 402 is used to transmit actual repetitions 3002, 3003, and 3005.

Other number of spatial relation information is also supported in the present application, for example, when there are three spatial relation information, e.g., #1, #2 and #3, then the cyclical mapping pattern is #1 #2 #3 #1 #2 #3 . . . . Then nominal repetition 2000 and nominal repetition 2003 are associated with spatial relation information 401, nominal repetition 2001 is associated with spatial relation information 402, and nominal repetition 2002 is associated with spatial relation information 403.

FIG. 4(b) illustrates a mapping result of another exemplary method for mapping repetitions based on sequential mapping pattern and beam mapping per nominal repetition according to some embodiments of the present application.

Similarly, when the mapping scheme is beam mapping per nominal repetition, a UE may associate each nominal repetition with a corresponding spatial relation information of the plurality of spatial relation information based on the mapping pattern. Accordingly, in FIG. 4(b), based on sequential mapping pattern, the first nominal repetition, i.e., nominal repetition 2000, and the second nominal repetition, i.e., nominal repetition 2001 are associated with spatial relation information 401, e.g., beam 401; the third nominal repetition, i.e., nominal repetition 2002, and the fourth nominal repetition, i.e., nominal repetition 2003 are associated with spatial relation information 402, e.g., beam 402.

Furthermore, when the mapping scheme is beam mapping per nominal repetition, all actual PUSCH repetitions within each single nominal repetition will be transmitted using the corresponding spatial relation information associated with the single nominal repetition. Based on the above, actual repetitions 3000 and 3001 are in nominal repetition 2000, actual repetitions 3002 and 3003 are in nominal repetition 2001. Accordingly, spatial relation information 401 is used to transmit actual repetitions 3000, 3001, 3002, and 3003. Similarly, actual repetition 3004 is in nominal repetition 2002, and actual repetition 3005 is in nominal repetition 2003. Accordingly, spatial relation information 402 is used to transmit actual repetitions 3004 and 3005.

FIG. 5(a) illustrates a mapping result of an exemplary method for mapping repetitions based on cyclical mapping pattern and beam mapping per actual repetition according to some embodiments of the present application.

As stated above, when the mapping scheme is beam mapping per actual repetition, a UE may associate each actual repetition with a corresponding spatial relation information of the plurality of spatial relation information based on the mapping pattern. Accordingly, in FIG. 5(a), based on the cyclical mapping pattern, first actual repetition, i.e., actual repetition 3000 is associated with spatial relation information 401, e.g., beam 401; the second actual repetition, i.e., actual repetition 3001 is associated with spatial relation information 402, e.g., beam 402; the third actual repetition, i.e., actual repetition 3002 is associated with spatial relation information 401, e.g., beam 401; the fourth actual repetition, i.e., actual repetition 3003 is associated with spatial relation information 402, e.g., beam 402, the fifth actual repetition, i.e., actual repetition 3004 is associated with spatial relation information 401, e.g., beam 401; and the sixth actual repetition, i.e., actual repetition 3005 is associated with spatial relation information 402, e.g., beam 402.

In conclusion, spatial relation information 401 is used to transmit actual repetitions 3000, 3002, and 3004; and spatial relation information 402 is used to transmit actual repetitions 3001, 3003, and 3005.

Other number of spatial relation information is also supported in the present application, for example, when there are three spatial relation information, e.g., #1, #2 and #3, then the cyclical mapping pattern is #1 #2 #3 #1 #2 #3 . . . . Then spatial relation information 401 is associated with actual repetition 3000 and actual repetition 3003, spatial relation information 402 is associated with actual repetition 3001 and actual repetition 3004, and spatial relation information 403 is associated with actual repetition 3002 and actual repetition 3005.

FIG. 5(b) illustrates a mapping result of another exemplary method for mapping repetitions based on sequential mapping pattern and beam mapping per slot according to some embodiments of the present application.

Similarly, when the mapping scheme is beam mapping per slot, a UE may associate each slot of a plurality of allocated slots for the PUSCH transmission with a corresponding spatial relation information of the plurality of spatial relation information based on the mapping pattern. Accordingly, in FIG. 5(b), based on sequential mapping pattern, the first actual repetition, i.e., actual repetition 3000, and the second actual repetition, i.e., actual repetition 3001, are associated with spatial relation information 401, e.g., beam 401; the third actual repetition, i.e., actual repetition 3002, and the fourth actual repetition, i.e., actual repetition 3003 are associated with spatial relation information 402, e.g., beam 402, the fifth actual repetition, i.e., actual repetition 3004, and the sixth actual repetition, i.e., actual repetition 3005 is associated with spatial relation information 401, e.g., beam 401.

In conclusion, spatial relation information 401 is used to transmit actual repetitions 3000, 3001, 3004, and 3005; and spatial relation information 402 is used to transmit actual repetitions 3002 and 3003.

Other number of spatial relation information is also supported in the present application, for example, when there are three spatial relation information, e.g., #1, #2 and #3, then the cyclical mapping pattern is #1 #1 #2 #2 #3 #3 . . . . Then spatial relation information 401 is associated with actual repetition 3000 and actual repetition 3001, spatial relation information 402 is associated with actual repetition 3002 and actual repetition 3003, and spatial relation information 403 is associated with actual repetition 3004 and actual repetition 3005.

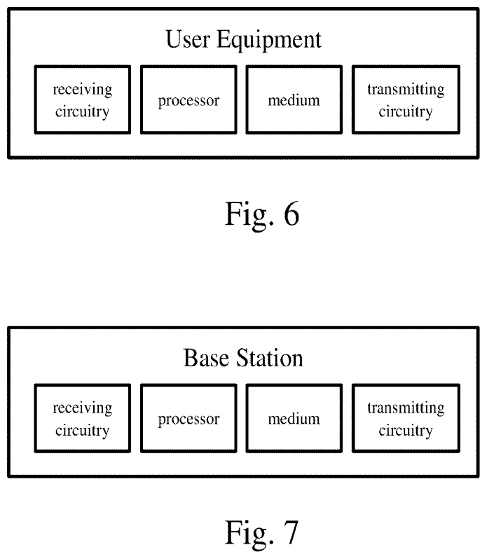

FIG. 6 illustrates a block diagram of an apparatus for mapping PUSCH repetitions according to some embodiments of the present application, which can be a UE or the like.

The UE may include a receiving circuitry, a processor, and a transmitting circuitry. In one embodiment, the UE may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g., the method in FIG. 2) with the receiving circuitry, the transmitting circuitry and the processor. That is, upon performing the computer executable instructions, the receiving circuitry receives configuration information indicating a mapping pattern of a plurality of spatial relation information and a number of nominal PUSCH repetitions of a PUSCH transmission using the plurality of spatial relation information, the processor determines a plurality of actual PUSCH repetitions using the plurality of spatial relation information based on the number of the nominal PUSCH repetitions, and the transmitting circuitry transmits the plurality of actual PUSCH repetitions using the plurality of spatial relation information based on the mapping pattern and a mapping scheme, wherein the mapping scheme is one of: beam mapping per slot, beam mapping per nominal repetition and beam mapping per actual repetition.

FIG. 7 illustrates a block diagram of an apparatus for mapping PUSCH repetitions according to some other embodiments of the present application, which can be a BS or the like.

The BS may include a receiving circuitry, a processor, and a transmitting circuitry. In one embodiment, the UE may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g., the method in FIG. 2) with the receiving circuitry, the transmitting circuitry and the processor. That is, upon performing the computer executable instructions, the transmitting circuitry transmits configuration information indicating a mapping pattern of a plurality of spatial relation information and a number of nominal PUSCH repetitions of a PUSCH transmission using the plurality of spatial relation information, the processor determines a plurality of actual PUSCH repetitions using the plurality of spatial relation information based on the number of the nominal PUSCH repetitions, and the receiving circuitry receives the plurality of actual PUSCH repetitions using the plurality of spatial relation information based on the mapping pattern and a mapping scheme, wherein the mapping scheme is one of: beam mapping per slot, beam mapping per nominal repetition and beam mapping per actual repetition.

The method of the present application can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method, comprising:
receiving configuration information indicating a mapping pattern of a plurality of spatial relation information and a number of nominal physical uplink shared channel (PUSCH) repetitions of a PUSCH transmission using the plurality of spatial relation information;
determining actual PUSCH repetitions using the plurality of spatial relation information based on the number of the nominal PUSCH repetitions; and
transmitting the actual PUSCH repetitions using the plurality of spatial relation information based on the mapping pattern and a mapping scheme, the mapping scheme being at least one of beam mapping per slot, beam mapping per nominal repetition, or beam mapping per actual repetition.

2. The method of claim 1, wherein the mapping pattern of the plurality of spatial relation information is one of a cyclical mapping pattern or a sequential mapping pattern.

3. The method of claim 1, wherein the configuration information is received by at least one radio resource control (RRC) signaling.

4. The method of claim 1, wherein the PUSCH transmission is a PUSCH repetition Type B transmission.

5. The method of claim 1, wherein the mapping scheme is beam mapping per slot, and the method comprises:
associating each slot of a plurality of allocated slots for the PUSCH transmission with a corresponding spatial relation information of the plurality of spatial relation information based on the mapping pattern; and
transmitting all of the actual PUSCH repetitions within each single slot using the corresponding spatial relation information associated with the single slot.

6. The method of claim 1, wherein the mapping scheme is beam mapping per nominal repetition, and the method further comprises:
associating each nominal PUSCH repetition of the PUSCH transmission with a corresponding spatial relation information of the plurality of spatial relation information based on the mapping pattern; and
transmitting all of the actual PUSCH repetitions within each single nominal PUSCH repetition using the corresponding spatial relation information associated with the single nominal PUSCH repetition.

7. The method of claim 1, wherein the mapping scheme is beam mapping per actual repetition, and the method further comprises:
associating each of the actual PUSCH repetitions with a corresponding spatial relation information of the plurality of spatial relation information based on the mapping pattern.

8. The method of claim 1, wherein the plurality of spatial relation information is two beams.

9-16. (canceled)

17. An apparatus, comprising:
a receiving circuitry;
a transmitting circuitry; and
a processor coupled to the receiving circuitry and the transmitting circuitry configured to cause the apparatus to:
receive configuration information indicating a mapping pattern of a plurality of spatial relation information and a number of nominal p se uplink shared channel (PUSCH) repetitions of a PUSCH transmission using the plurality of spatial relation information;
determine actual PUSCH repetitions using the plurality of spatial relation information based on the number of the nominal PUSCH repetitions; and
transmit the actual PUSCH repetitions using the plurality of spatial relation information based on the mapping pattern and a mapping scheme, the mapping scheme being at least one of beam mapping per slot, beam mapping per nominal repetition, or beam mapping per actual repetition.

18. An apparatus, comprising:
a receiving circuitry;
a transmitting circuitry; and
a processor coupled to the receiving circuitry and the transmitting circuitry configured to cause the apparatus to:
transmit configuration information indicating a mapping pattern of a plurality of spatial relation information and a number of nominal physical uplink shared channel (PUSCH) repetitions of a PUSCH transmission using the plurality of spatial relation information;
determine actual PUSCH repetitions using the plurality of spatial relation information based on the number of the nominal PUSCH repetitions; and
receive the actual PUSCH repetitions using the plurality of spatial relation information based on the mapping pattern and a mapping scheme, the mapping scheme being at least one of beam mapping per slot, beam mapping per nominal repetition, or beam mapping per actual repetition.

19. The apparatus of claim 18, wherein:
the mapping pattern of the plurality of spatial relation information is one of a cyclical mapping pattern or a sequential mapping pattern;
the configuration information is received by at least one radio resource control (RRC) signaling; and
the PUSCH transmission is a PUSCH repetition Type B transmission.

20. The apparatus of claim 18, wherein the mapping scheme is beam mapping per slot, and the processor coupled to the receiving circuitry and the transmitting circuitry is configured to cause the apparatus to:
associate each slot of a plurality of allocated slots for the PUSCH transmission with a corresponding spatial relation information of the plurality of spatial relation information based on the mapping pattern; and
receive all of the actual PUSCH repetitions within each single slot using the corresponding spatial relation information associated with the single slot.

21. The apparatus of claim 18, wherein the mapping scheme is beam mapping per nominal repetition, and the processor coupled to the receiving circuitry and the transmitting circuitry is configured to cause the apparatus to:
associate each nominal PUSCH repetition of the PUSCH transmission with a corresponding spatial relation information of the plurality of spatial relation information based on the mapping pattern; and
receive all of the actual PUSCH repetitions within each single nominal PUSCH repetition using the corresponding spatial relation information associated with the single nominal PUSCH repetition.

22. The apparatus of claim 18, wherein the mapping scheme is beam mapping per actual repetition, and the processor coupled to the receiving circuitry and the transmitting circuitry is configured to cause the apparatus to associate each of the actual PUSCH repetitions with a corresponding spatial relation information of the plurality of spatial relation information based on the mapping pattern.

23. The apparatus of claim 18, wherein the plurality of spatial relation information is two beams.

24. The apparatus of claim 17, wherein:
the mapping pattern of the plurality of spatial relation information is one of a cyclical mapping pattern or a sequential mapping pattern;
the configuration information is received by at least one radio resource control (RRC) signaling; and
the PUSCH transmission is a PUSCH repetition Type B transmission.

25. The apparatus of claim 17, wherein the mapping scheme is beam mapping per slot, and the processor coupled to the receiving circuitry and the transmitting circuitry is configured to cause the apparatus to:
associate each slot of a plurality of allocated slots for the PUSCH transmission with a corresponding spatial relation information of the plurality of spatial relation information based on the mapping pattern; and
transmit all of the actual PUSCH repetitions within each single slot using the corresponding spatial relation information associated with the single slot.

26. The apparatus of claim 17, wherein the mapping scheme is beam mapping per nominal repetition, and the processor coupled to the receiving circuitry and the transmitting circuitry is configured to cause the apparatus to:
associate each nominal PUSCH repetition of the PUSCH transmission with a corresponding spatial relation information of the plurality of spatial relation information based on the mapping pattern; and
transmit all of the actual PUSCH repetitions within each single nominal PUSCH repetition using the corresponding spatial relation information associated with the single nominal PUSCH repetition.

27. The apparatus of claim 17, wherein the mapping scheme is beam mapping per actual repetition, and the processor coupled to the receiving circuitry and the transmitting circuitry is configured to cause the apparatus to associate each of the actual PUSCH repetitions with a corresponding spatial relation information of the plurality of spatial relation information based on the mapping pattern.

28. The apparatus of claim 17, wherein the plurality of spatial relation information is two beams.
